(19) United States
(12) Patent Application Publication
(10) Pub. No.: US 2024/0083760 A1
(43) Pub. Date: Mar. 14, 2024

(54) Delivery of Concentrated Sodium Chlorite

(71) Applicant: ArrowUp, LLC, St. Louis, MO (US)

(72) Inventor: Eric Guy Sumner, St. Louis, MO (US)

(73) Assignee: ArrowUp, LLC, St. Louis, MO (US)

(21) Appl. No.: 18/367,984

(22) Filed: Sep. 13, 2023

Related U.S. Application Data
(60) Provisional application No. 63/406,066, filed on Sep. 13, 2022.

(51) Int. Cl. C01D 13/00

(52) U.S. Cl. CPC C01D 13/00

(57) ABSTRACT

The present disclosure is directed to improved, high concentration NaClO₂ compositions, methods for making them, and methods of use.

### RELATED APPLICATIONS

This application claims the benefit of U.S. Provisional Application No. 63/406,066, entitled “Delivery of Concentrated Sodium Chlorite,” and filed on Sep. 13, 2022, which is incorporated herein by reference in its entirety for all purposes.

### FIELD OF THE DISCLOSURE

The present disclosure relates generally to the formulation, area of manufacture, and methods of use of solutions of concentrated sodium chlorite.

### BACKGROUND

Sodium chlorite (NaClO₂) has been used industrially for sanitation, the control of microbial contamination, bleaching, and water treatment. One exemplary industrial use of sodium chlorite is control of lactic and acetic acid producing bacterial contamination. Sodium chlorite is also used for managing microorganisms in many applications, including drinking water disinfection, wastewater treatment, and food processing to name a few.

Currently, sodium chlorite is offered in aqueous liquid or in a dry or solid form. Liquid is available in typically inconvenient dilute form, sold commercially from approximately 2.5 percent to approximately 40 percent sodium chlorite, by weight. Higher concentrations of aqueous sodium chlorite are not produced due to the issue of precipitation, i.e. “salting out”. In this form, sodium chlorite solutions cannot be delivered in a homogenous state.

Liquid sodium chlorite that leaks or spills can lead to dried sodium chlorite residue which is highly unstable and can lead to spontaneous and violent decomposition, which is very exothermic and highly energetic, creating an unsafe event that can lead to an explosion or fire. In addition to the risk of leakage and decomposition, sodium chlorite is typically diluted with water into an aqueous form to be able to store and transport. This dilution results in costly storage and transportation costs due to the mass of dilution water required. This includes the volumetric space for storage, and the footprint required to contain, transport, and handle such material. This disadvantage can necessitate a storage tank or a large area of self-contained floor space to handle numerous totes, pallets of drums, or similar sizable packaging. In addition, the cost of storing such sodium chlorite is expensive due to the unique materials of construction required to manage the corrosivity of the material in large volumes.

Since solid, pure sodium chlorite is inherently unstable, it is blended with stabilizers that minimize the risk of undesirable events when commercially produced. Solid sodium chlorite is available at up to approximately 80 percent sodium chlorite and includes, for example, additional stabilizers such as sodium chloride and small amounts of water (approximately 5 percent or less).

There remains a need for improved commercially useful delivery methods and formulations of high concentration sodium chlorite suspensions having improved stability, storage, and transport characteristics.

### SUMMARY

Disclosed herein are new liquid, slurry, or suspension formulations of sodium chlorite, methods for producing them, methods of use, and methods of delivery thereof.

The novel compositions and methods disclosed herein advantageously increase the concentration of sodium chlorite while allowing a decreased amount of water to form a stable, slurry of sodium chlorite that is high in thixotropy, thereby reducing flowability, and the tendency for the material to settle, separate, spill, or leak.

This slurry of sodium chlorite can be produced in a slurry, gel or paste that has increased stability, higher sodium chlorite concentrations, and increased water retention due to the presence of the rheology modifiers. The water content of the compositions of the present disclosure ranges from about 20 to about 60 percent water. Viscosity of the sodium chlorite slurry material can range from 1,000 (e.g., for lower solids systems) to 200,000,000 (twice that of window putty) centipoise.

The sodium chlorite slurry may optionally include stabilizing materials to prevent phase separation. Stabilizing materials that prevent phase separation can include, but are not limited to, rheology modifiers, such as, fumed silica, aluminum oxide, diatomaceous earth, clay, and similar inorganic, non-oxidizable thickening agents. The concentration of stabilizing materials can range from 0.1 to 20 percent by weight.

One advantage of compositions that include rheology modifiers is that they are no longer transparent, but rather are opaque and/or grey in appearance, facilitating the recognition and identification of spills containing the semi-solid sodium chlorite in various settings. This is a significant improvement over prior solutions of sodium chlorite, which can go unrecognized for sufficient time to allow the water in the solutions to evaporate leaving a salt residue of sodium chlorite at the site of the spill and risking explosive reactions when such salt is disturbed or compressed. The sodium chlorite slurry, by comparison, is readily observable due to its color and lower tendency to absorb into porous surfaces, allowing for improved recognition and remediation of hazards associated with a sodium chlorite spill.

In addition, it was surprisingly discovered that the addition of a rheology modifier dramatically increases drying time, allowing for additional time to remediate the hazards associated with a sodium chlorite spill.

Described herein are the means to safely process and produce an improved sodium chlorite product. These unit operations and methods can be employed due to the surprisingly stable semi-solid nature of the sodium chlorite formulation, making it not prone to decomposition, including, but not limited to, thermal decomposition. These unit operations can be used to either evaporate and concentrate sodium chlorite to a semi-solid formulation, or they optionally may be used to add water to a dry form of sodium chlorite and then prepare a homogeneous sodium chlorite slurry. The water content for the material produced by each of these ranges from 20 to 60 percent water.

Described herein are the means to safely manage, handle and apply a sodium chlorite slurry product. This system uses pneumatic or vacuum means to convey the sodium chlorite slurry and can be successfully and universally used in a variety of industrial applications that currently depend on traditional forms of sodium chlorite. An alternative is a package that releases sodium chlorite slurry, including but not limited to packaging that is water soluble, dissolves, degrades or disintegrates when delivered to aqueous solution. The advantages of the subject innovation support sodium chlorite application in many commercial uses, including but not limited to: drinking water disinfection, municipal and industrial wastewater treatment, bleaching, bacteria control in fermentation such as conventional, cellulosic and advanced, engineered yeast fermentation, as well as fermentation applications where fungal organism are used to produce food or pharmaceutical products such as drugs, and many others.

### BRIEF DESCRIPTION OF THE DRAWINGS

FIGS. 1A and 1B. The figure provides an embodiment of a system that can be used to transfer viscous material from rigid packaging to the desired injection point using pneumatic pressure and/or vacuum for conveyance of the material.

FIGS. 2A and 2B. The figure provides an embodiment of a system that can be used to transfer viscous material from flexible packaging to the desired injection point using pneumatic pressure and/or vacuum for conveyance of the material.

FIG. 3. The figure provides an embodiment of the viscosity that can be achieved with the sodium chlorite slurry compositions of the present disclosure.

FIG. 4. The figure provides an embodiment of the increased drying times for NaClO₂ slurry compositions that are made according to the present disclosure.

FIGS. 5A, 5B, and 5C. The figure provides an illustration of a spill of a sodium chlorite solution on a concrete surface, the relative obscurity of the solution on the surface, and the drying that will occur when the water contained within is absorbed by the concrete and evaporated into the air.

### DETAILED DESCRIPTION

In the following description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the scope of the present subject matter. Aspects of the present disclosure, including the Figures, can be arranged, substituted, combined, separated, and designed in a wide variety of different configurations, all of which are contemplated herein.

References in the specification to “one embodiment”, “an embodiment”, “an example embodiment” or “some embodiments,” etc. indicate that the embodiments described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be effected in connection with other embodiments whether or not explicitly described.

### Definitions

Unless otherwise defined herein, scientific and technical terms used in connection with the present disclosure shall have the meanings that are commonly understood by those of ordinary skill in the art. The meaning and scope of the terms should be clear, however, in the event of any latent ambiguity, definitions provided herein take precedent over any dictionary or extrinsic definition. Further, unless otherwise required by context, singular terms shall include pluralities and plural terms shall include the singular.

The term “about” is used herein to mean within the typical ranges of tolerances in the art. For example, “about” can be understood as about 2 standard deviations from the mean. According to certain embodiments, when referring to a measurable value such as an amount and the like, “about” is meant to encompass variations of ±20%, ±10%, ±5%, ±1%, ±0.9%, ±0.8%, ±0.7%, ±0.6%, ±0.5%, ±0.4%, ±0.3%, ±0.2% or ±0.1% from the specified value as such variations are appropriate to perform the disclosed methods. When “about” is present before a series of numbers or a range, it is understood that “about” can modify each of the numbers in the series or range.

The terms “sodium chlorite semi-solid,” “semi-solid sodium chlorite,” or “sodium chlorite slurry,” or “slurry of sodium chlorite” are used herein to describe the sodium chlorite compositions of the present disclosure that contain sodium chlorite in solution and/or suspension along with a stabilizer, such as a rheology modifier, and water in conditions that facilitate a homogeneous suspension of sodium chlorite particles.

The terms “oil and gas production” are used herein to describe the methods and processes used to drill for and extract petroleum products such as oil or natural gas from the ground.

The present discovery comprises a sodium chlorite semi-solid as a slurry, gel or paste for use in commercial applications, a process to produce it, and the delivery method for the material. The commercial applications may include but are not limited to municipal drinking water or wastewater treatment systems, industrial wastewater treatment systems, commercial food processing operations, commercial medical enterprises, pharmaceutical production operations, commercial fermentation operations, and the like where sodium chlorite is used in a process or operation. The semi-solid sodium chlorite is between 40 and 80 percent solids by weight.

In some embodiments, semi-solid material consisting of concentrated sodium chlorite and water are combined with a material, or materials, that are rheology modifiers and/or are unreactive with these ingredients. Such modifiers include, but are not limited to silica, fumed silica, aluminum oxide, diatomaceous earth, clay, and similar thickening agents. The resulting composition is very stable and does not exhibit the exothermic and energetic instability properties of dry sodium chlorite. Unexpectedly, it also retains water for much longer periods of time in ambient conditions, thereby facilitating safer identification and remediation of sodium chlorite spills.

In some embodiments, the material is produced by separating water from a dilute sodium chlorite solution produced according to currently known methods by those skilled in the art, or by adding water to a dry sodium chlorite powder, granules, crystals, pellets, flakes, or similar form and blending into a homogeneous semi-solid slurry, gel or paste, or by formulating ingredients to form the desired slurry directly, without separation of water, or without wetting dry sodium chlorite material with water. This includes stabilized sodium chlorite powder, for example, which typically includes approximately 20 percent sodium chloride.

In some embodiments, water can be removed from solution and thereby increase the concentration of the sodium chlorite solution through adsorption, absorption, crystallization (including, but not limited to, forced-circulation, draft tube baffle, surface-cooled, batch vacuum, etc.), distillation (including, but not limited to, packed beds, plate, vacuum, cryogenic, reactive, extractive, pressure swing, homogeneous azeotropic, heterogeneous azeotropic, etc.), drying methods (including, but not limited to, rotating drum drying, rotary drying, flash drying, fluidized bed drying, spray drying, conveyor drying, tray drying, thin-film drying, etc.), evaporation (including, but not limited to, agitated, thin-film evaporation, long-tube vertical evaporation, short-tube vertical evaporation, horizontal tube evaporation, forced circulation evaporation, nitrogen blowdown evaporation, etc.), extraction (including, but not limited to, mixer-settler extraction, centrifugal extraction, non-agitated column extraction, agitated column extraction, pulsated column extraction, graesser column extraction, solvent extraction, etc.), ion exchange separation (including, but not limited to, fixed bed ion exchange, mixed bed ion exchange, countercurrent ion exchange, continuous ion exchange, chromatographic separation, etc.), membrane separation (including, but not limited to, hydrostatic pressure membranes (including, but not limited to, microfiltration hydrostatic pressure membranes, ultrafiltration hydrostatic pressure membranes, reverse osmosis hydrostatic pressure membranes, gas separation hydrostatic pressure membranes), vapor pressure membrane separation (including, but not limited to, pervaporation vapor pressure membranes, membrane distillation vapor pressure membranes, etc.), electrical potential/electrodialysis membrane separation, concentration membrane separation (including, but not limited to, dialysis concentration membrane separation, facilitated transport concentration membrane separation, etc.)), and combinations thereof.

Also, various mechanical separation methods may be employed and combined with these processes to manage the separation and resulting desired concentration of sodium chlorite into a sodium chlorite slurry. These include, but are not limited to, centrifuges (including, but not limited to, tubular-bowl centrifuges, continuous decanter centrifuges, screen-bowl centrifuges, self-opening centrifuges, multi-chamber centrifuges, disk centrifuges, nozzle-discharge centrifuges, etc.), cyclones and hydrocyclones, electrostatic precipitators, filters (including, but not limited to, filter presses, pressure filters, vacuum filters, fabric filters, belt filters, depth bed filters, magnetic filters, ceramic filters, nutsche filters, etc.), gravity separators, screeners (including, but not limited to, flat screeners, trommel screeners, centrifugal screeners, grizzly screeners, sieve stack screeners, etc.), thickeners and clarifiers (circular clarifiers, parallel plate clarifiers, settling ponds or tanks or vessels, etc.) etc.

In some embodiments, the stability agents such as sodium chloride, fumed silica, or others such as those listed above may be added before, during or following separation, to achieve the desired sodium chlorite slurry characteristics, including water content, viscosity, and physical and chemical stability. This can be achieved using various methods of addition and mixing to achieve a homogeneous, stable material. Mixing is important throughout production, especially to ensure a uniform, homogeneous, and stable sodium chlorite slurry or matrix. Mixing techniques that are used include kneaders, extruders, tumblers, ribbon mixers, mullers, static mixers, mechanically mixed tanks, jet mixers, etc.

Another embodiment of a composition according to the present disclosure is provided below.
a. Make a 31-37% (w/w) solution of NaClO2 in H2O;
b. Remove water to generate a composition containing about 40% to 80% solids using methods provided herein;
c. Using high shear mixing, add fumed silica using a funnel to achieve a final concentration of fumed silica of about 0.5% to 2% (w/w) of concentrated solution;
d. Mix the composition for 2 hours, or until homogeneous using high shear mixing methods.
e. Optionally, reduce the water content of the composition through heating, evaporation, etc. until the composition has a viscosity between 1,000 and 100,000 centipoise depending on final water content.

Different polishing techniques may be used, if needed, to adjust the particle size and dispersion of the sodium chlorite semi-solid matrix during production. This includes but is not limited to compression crushers, impact crushers, grinders (including, but not limited to, pulverizers, attrition mills, cone mills, tumbling mills, vertical spindle mills, mechanical impact mills, roller compactors, cryogenic grinders, etc.).

In some embodiments, the resulting product is packaged into an appropriate container to provide a means of maintaining stability and the desired water content. Package size can vary from a small tube, cartridge, pouch, bag, to a bucket, canister, drum, tote, or tank or similar type vessels. Packaging material of construction can be polymeric such as CPVC, PVC, HDPE, PTFE, PFA, FEP, fluorinated polyethylene, polyvinyl fluoride, fiber reinforced plastic, polypropylene lined, rubber (latex, butyl, silicone, etc.), glass or ceramic, or of a metallic corrosion resistant alloy such as Hastelloy-C, titanium, 316 stainless steel, or a combination thereof such as a lined, laminated, bonded or similar material. In another embodiment, the package might be lined and a container such as the above or a package consisting of a bag, or film made of a rubber (butyl, silicone, etc.), or polymer such as CPVC, PVC, HDPE, PTFE, PFA, FEP, fluorinated polyethylene, polyester, fiber reinforced plastic or metallic foil or a combination thereof, which is inert and corrosion resistant to sodium chlorite matrix.

In another embodiment, the packaging may be a water soluble or dissolving material or others such material as those listed above that allows direct application of the semi-solid sodium chlorite to a tank or vessel that incudes water, such as an addition tank, chemical mix tank, a mash fermenter, a chemical processing vessel, a water treatment tank or similar vessel.

In some embodiments, delivery of the sodium chlorite slurry is performed using a pressure delivery mechanism such as a plunger or other mechanism to exert compression on the packaging such as a vise, expandable bladder, compression chamber, etc. when used in a cartridge, drum, box, cylinder, tote or the like to push and deliver material under pressure.

In another embodiment, the material can be pulled under vacuum. Each of these can use a sealed plunger or press mechanism to minimize or eliminate remaining material or residue left in a used package. This minimizes or eliminates potential risk of sodium chlorite residue drying into a solid, which might result in potential damaging decomposition event. Pressure or vacuum can vary according to viscosity and volume delivery requirements from low to high, depending various design factors such as friction loses, delivery pump characteristics, injection point back pressure, etc.

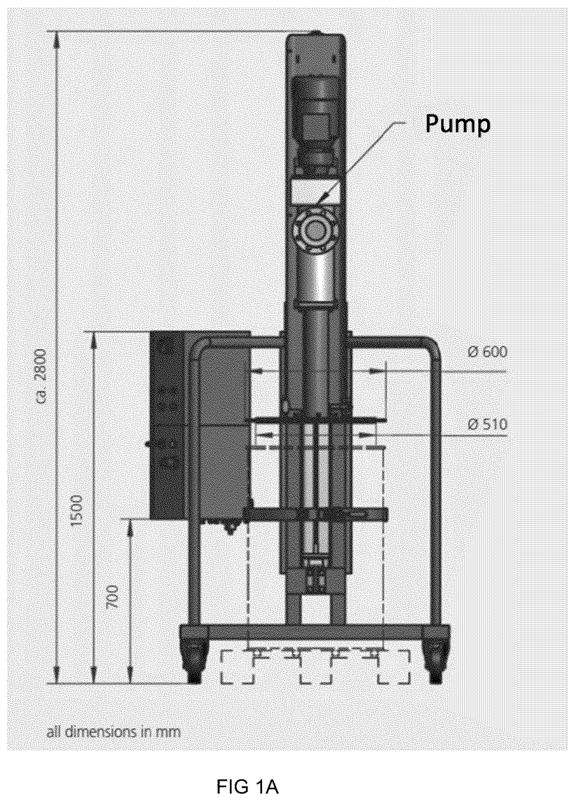

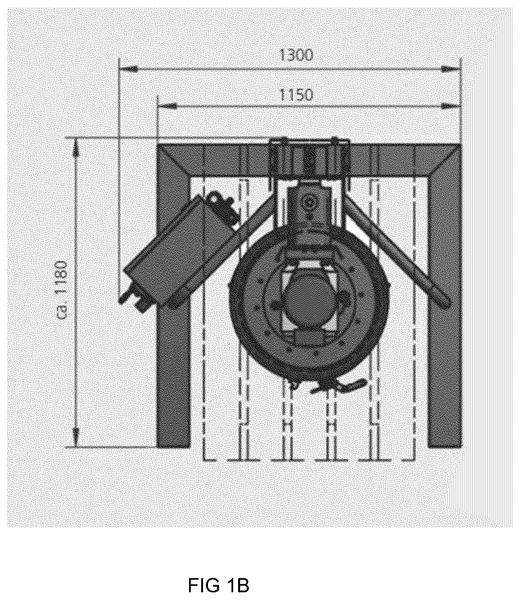

One embodiment of such a mechanism is shown in FIG. 1. This system is used to transfer viscous material from rigid packaging to the desired injection point using pneumatic pressure and/or vacuum for conveyance of the material. This system can be operated either manually or automated.

The equipment in FIG. 1. consists of a free-standing frame that may be equipped with or without wheels. Attached to the frame are the primary components of the system and include: a control box with electric and programmable logic control (PLC) components, a vertical structural column for attaching pumps, feed lines, hoses, piping, cabling and/or wiring harnesses, presses or drives, bands for rigid container stabilization, platforms for containers, etc. The pump is used to transfer the product to a given operations injection point via a hose, feed line, or pipe. This transfer is typically performed under positive pressure but might also be performed by pulling a vacuum on the system. The material of construction for this system is primarily stainless steel, but with subcomponents of plastics, rubbers, or other materials as stated above.

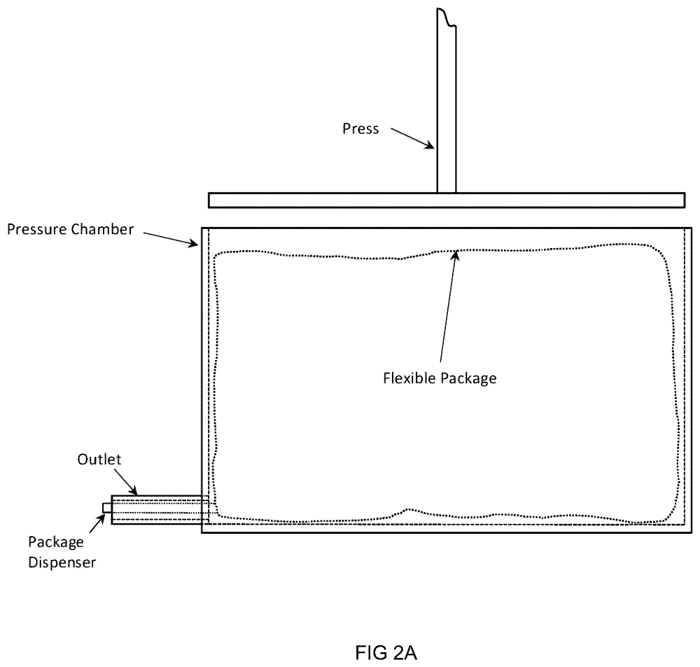

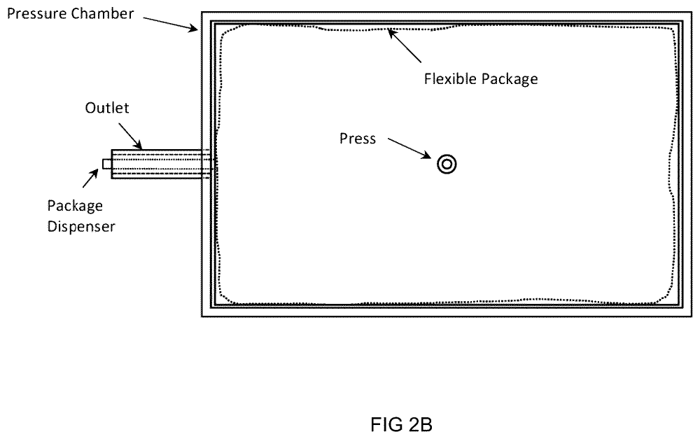

Another embodiment of such a mechanism is shown in FIG. 2. This system is an embodiment of what can be used to transfer viscous material from flexible packaging to the desired injection point using pneumatic pressure and/or vacuum for conveyance of the material. This system can be operated either manually or automated.

The equipment in FIG. 2 consists of a chamber that is used to hold flexible packaging. The chamber has one side that has a press or plunger to exert pressure on the flexible package and thereby squeeze the sodium chlorite slurry into the injection line downstream of the outlet. The material of construction for this system is primarily stainless steel, but with subcomponents of plastics, rubbers, or other materials as stated above. Alternatively, the material may be transferred by pulling a vacuum on the package dispenser.

Another embodiment is a water soluble or disintegrating when wetted pouch, bag or container that contains the sodium chlorite slurry and can be automatically or manually dropped into a vessel that contains water, where the package loses its strength and falls apart with the sodium chlorite slurry being broken up and allowed to thoroughly dissolve, and the material then added to the desired application.

The delivery system may include a mechanism for rinsing spent rigid or flexible packaging and/or related equipment of residual sodium chlorite to leave it residue free, thereby minimizing risk of decomposition. This mechanism can be operated automatically or manually. Rinsate flow is controlled and directed to the appropriate treatment process in the facility. This is to allow it to be disposed of according to necessary and required treatment practices such as wastewater collection, chemical treatment, or other disposal practice for the facility.

### EXAMPLES

The below examples provide specific embodiments. The specific embodiments show exemplary compositions and methods for making them according to the present disclosure, but the use of these specific examples is not intended to be limiting.

### Example 1

A sodium chlorite slurry can be made according to the composition and method described in this example. A person of skill would understand that the below composition is one embodiment of the present disclosure and can be increased to industrial scale.

1. A 65% NaClO₂ w/w solution was prepared by heating a 31% NaClO₂ w/w solution to 65° C. for 24 hours.

2. A fumed silica, Cab-O-Sil® M5 was added at 0.5%, 1.0%, 1.5%, 2.0%, and 2.5% concentrations (w/w) to 50 ml aliquots of 65% NaClO₂ solution (w/w) and mixed for 2 hours with a medium speed magnetic stir bar to ensure complete dispersion.

3. Solutions were placed in glass jars and allowed to rest for 48 hours.

4. After 48 hour solutions were observed for visible settling.

5. Result at 48 hours as follows:
a. 0.5%=heavy settling;
b. 1.0%=moderate settling;
c. 1.5%=light settling;
d. 2.0%=no settling;
e. 2.5%=no settling;
6. Solutions were observed again at 96 hours will some additional settling in a-c and no change in solutions d-e.

The inventors discovered that a rheology modifier can be used to stabilize high concentration sodium chlorite solutions and thus achieve the compositions of the present disclosure while also preventing precipitation of the sodium chlorite contained within. All of the resulting compositions appeared semi-transparent gray, with settling of the solids within being observed only at the concentration of 1.5% and below.

A person of skill would recognize the benefits of using different concentrations or types of rheology modifiers to stabilize sodium chlorite solutions of these types and reveals some of the benefits that can be achieved using the technology of the present disclosure. For example, a person of skill would understand that lower concentrations of certain rheology modifiers could be used to achieve the same results (such as using fumed silica with an optimized or different morphology than Cab-O-Sil® M5, mixtures of different rheology modifiers, etc.).

### Example 2

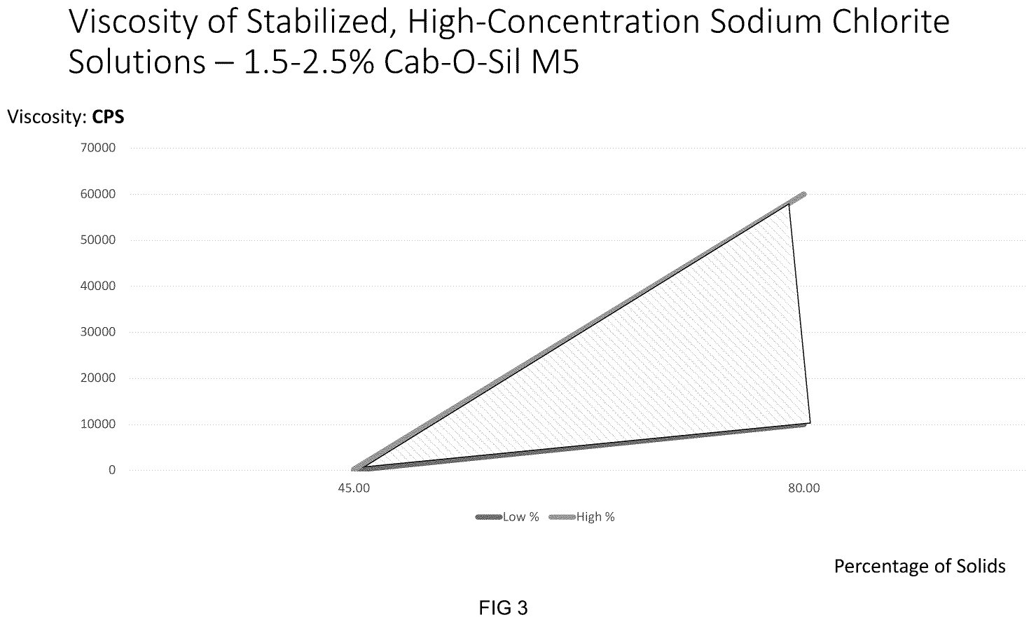

The viscosity of one embodiment of the present disclosure was tested using the following procedure. A 300 ml sample of 31% (w/w) solids NaClO₂ solution measured for viscosity on a Brookfield RVDV II viscometer, using a #2 spindle, read at 50 cps, and then dried at 60° C. to 45% solids, at which point NaClO₂ began to precipitate. At that point, Cab-O-Sil® M5 was added to the solution to achieve a 2% concentration of Cab-O-Sil® (w/w) and the solution was measured for viscosity. Over time, the solution was dried down at 75° C. Every 2 hours, the solution was cooled and measured again for viscosity, and a 1 g sample was tested for solids. Once the solution was 80% solids, testing was completed. Since viscosity can vary broadly, depending on 1) level of rheology modifier, 2) identity of rheology modifier, 3) temperature, and 4) total solids, a broad range of possible viscosities for this product was charted as illustrated in FIG. 3.

### Example 3

The drying time of different NaClO₂ compositions were tested according to the below procedures. Two samples were prepared: one standard sample (a); and one sodium chlorite slurry sample (b).
a. 65% (w/w) NaClO₂ in H₂O;
b. 65% (w/w) NaClO₂+2% Cab-O-Sil M5® (w/w) in H₂O

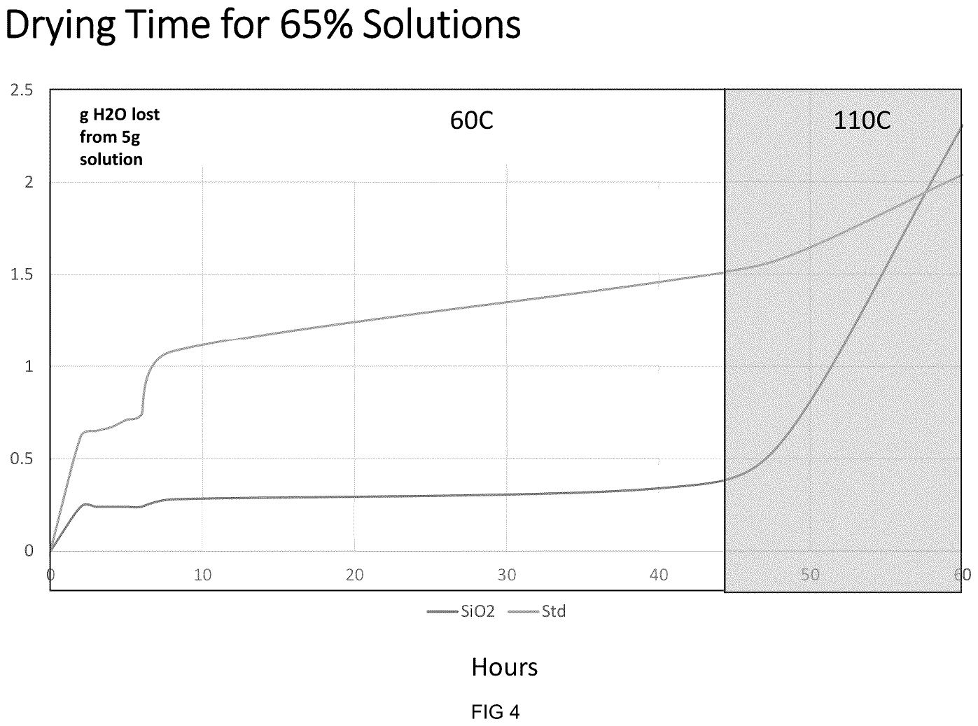

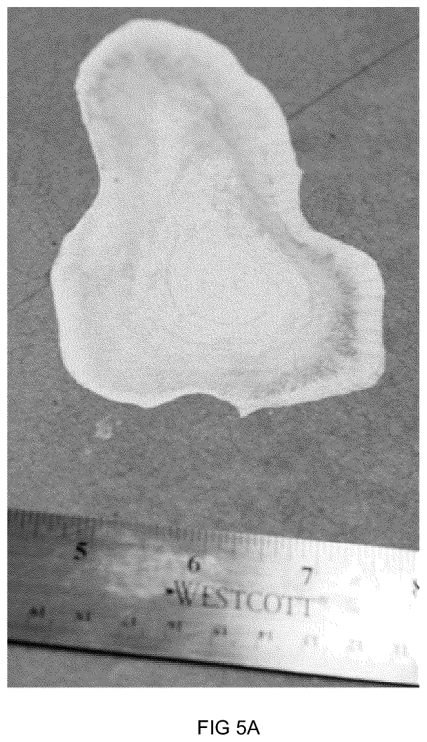

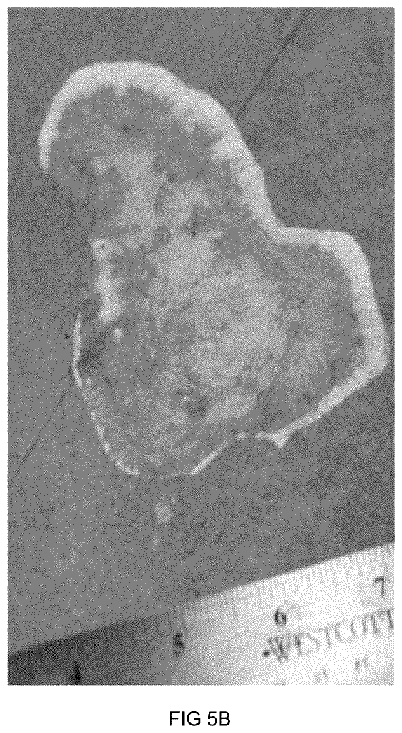

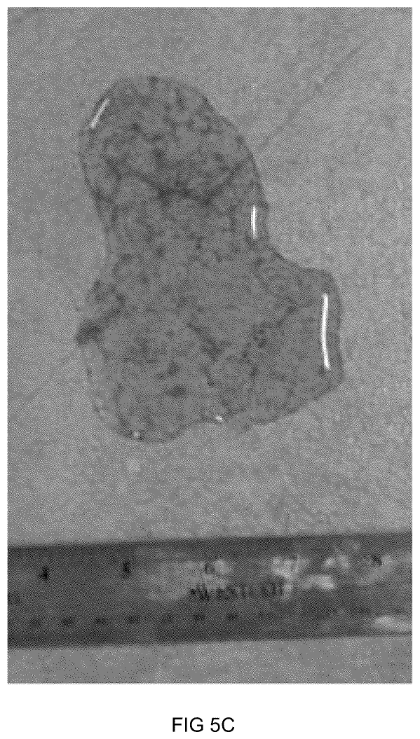

5 g of each sample were placed in glass drying dishes in a 60° C. oven to accelerate drying of the solutions. Weight loss of the compositions over time was recorded. At 45 hours, temperature was increased to 110° C. to force drying. Drying of both formulations was completed at 60 Hours. Surprisingly, the water content of the sodium chlorite slurry composition stabilized a few hours into the experiment and very little additional water was lost for the next 40 hours (at least until the temperature was shifted to 110° C. to force drying). By comparison, the solution containing only sodium chlorite and water showed significant water evaporation throughout the test, with approximately 1.5 grams of H2O evaporated from the standard sample by hour 40. See FIG. 4, with the dark line showing the sodium chlorite slurry composition and the lighter line showing the standard composition.

What is claimed is:

1. A composition comprising: sodium chlorite (NaClO₂), water, and a rheology modifier.

2. The composition of claim 1, wherein the rheology modifier is selected from the group consisting of: silica, fumed silica, precipitated calcium carbonate, aluminum oxide, diatomaceous earth, clay, talc, and organoclays.

3. The composition of claim 2, wherein the rheology modifier is selected from the group consisting of silica and fumed silica.

4. The composition of claim 3, wherein the concentration of sodium chlorite is from about 40% to about 80% by weight of the solution.

5. The composition of claim 3, wherein a 65% solution of sodium chlorite by weight remains in the slurry for more than about 50 hours at 60° C.

6. The composition of claim 2, wherein the clay is selected from the group consisting of: attapulgite clay, bentonite clay, hectorite clays, and organoclay.

7. Method of using the composition of claim 1 selected from the group consisting of: wastewater treatment, sanitation, textile production, paper production, produce production, food production, herbicide production, oil and gas production, as a pesticide, as a fungicide, as an anti-microbial, and as an algaecide.

8. Method of using the composition of claim 2 selected from the group consisting of: wastewater treatment, sanitation, textile production, paper production, produce production, food production, herbicide production, oil and gas production, as a pesticide, as a fungicide, as an anti-microbial, and as an algaecide.

9. Method of using the composition of claim 3 selected from the group consisting of: wastewater treatment, sanitation, textile production, paper production, produce production, food production, herbicide production, oil and gas production, as a pesticide, as a fungicide, as an anti-microbial, and as an algaecide.

10. A composition comprising sodium chlorite, water, and a rheology modifier, wherein the concentration of the rheology modifier in the solution is greater than about 0.5% per weight of the total solution.

11. The composition according to claim 10, wherein the concentration of the rheology modifier in the solution is greater than about 0.8% per weight of the total solution.

12. The composition according to claim 10, wherein the concentration of the rheology modifier in the solution is greater than about 1.0% per weight of the total solution.

13. The composition according to claim 10, wherein the concentration of the rheology modifier in the solution is greater than about 1.2% per weight of the total solution.

14. The composition according to claim 10, wherein the concentration of the rheology modifier in the solution is greater than about 1.5% per weight of the total solution.

15. A composition comprising: sodium chlorite (NaClO₂), water, and at least one stabilizer.

16. The composition of claim 15, wherein the at least one stabilizer is selected from the group consisting of: silica, fumed silica, precipitated calcium carbonate, aluminum oxide, diatomaceous earth, clay, talc, and organoclays.

17. The composition of claim 15, wherein the at least one stabilizer comprises: silica, sodium chloride, or fumed silica.

18. The composition of claim 17, wherein the concentration of the at least one stabilizer is from about 0.1 to 20% by weight of the total solution.

19. The composition of claim 3, wherein the viscosity is from about 1,000 to about 200,000,000 centipoise.
